(19) United States
(12) Patent Application Publication
(10) Pub. No.: US 2010/0255274 A1
(43) Pub. Date: Oct. 7, 2010

(54) DEEP ANODIZATION

(76) Inventors: Uri Mirsky, Nofit (IL); Shimon Neftin, Kiryat Shmonah (IL); Lev Furer, Haifa (IL)

Correspondence Address: BROWDY AND NEIMARK, P.L.L.C.;624 NINTH STREET, NW, SUITE 300, WASHINGTON, DC, 20001-5303, US

(21) Appl. No.: 12/601,662

(22) PCT Filed: May 25, 2008
(86) PCT No.: PCT/IL08/00705

§ 371 Date: Jun. 1, 2010

(51) Int. Cl. B32B 15/20; C25D 9/06

(52) U.S. Cl. 428/209; 205/118

(57) ABSTRACT

A method of anodizing comprising anodizing at least a portion of a valve metal base to a depth of at least 200 μm.

### FIELD

The invention relates to anodized substrates.

### BACKGROUND

Anodizing, or controlled oxidation, is an electrochemical process typically used to build a thickness and a density of a naturally forming oxide layer on a surface of a metal. For convenience hereinafter, a metal on which an oxide layer is formed, either naturally or through anodizing, will be referred to as a “substrate”. By increasing the thickness and density of the oxide layer anodizing generally provides for improved corrosion and wear resistance in the substrate. Additionally, it provides for substantially better adhesion of paints, and/or epoxies, and/or other protective/decorative coating materials onto the base. Optionally, it provides for electrical isolation.

Aluminum and aluminum alloys are examples of types of metals on which a protective oxide layer naturally forms along the surface when the surface is exposed to the atmosphere. The oxide layer is generally adapted to moderately protect the metal from corrosion. For convenience hereinafter, the metal, prior to the formation of an oxide layer shall be referred to as “base”. In order to have increased protection over that provided by the naturally formed oxide layer, the base generally undergoes anodizing. Typically, for aluminum and aluminum alloys, anodizing is performed by submerging the base in a solution soluble to aluminum oxide (Alox), such as oxalic acid, phosphoric acid, sulphuric acid, chromic acid or any other appropriate material. A direct current is passed through the solution, the base acting as an anode, or positive electrode and an electrode inserted in the solution acting as a negative electrode, or cathode. As a result of the current, hydrogen is released by the solution at the cathode, and oxygen is released at the surface of the base acting as the anode. The released oxygen produces a buildup of the Alox layers on the surface of the base. The dimensions of the Alox layers are typically controlled during an anodization process by controlling duration of the process, current density, voltage between the electrodes, temperature of the solution, or any combination thereof.

Numerous applications require the substrates to have relatively large heat transfer characteristics. Examples of such applications may comprise devices used in high temperature environments such as may be found, for example, in high performance light engines, ovens for component fabrication, high power laser equipment and high power RF device and/or equipment. Other examples may comprise devices used in lower temperature environments such as may be found in high power small volume, for example ˜100 W/cm² or more, devices and/or equipment, mobile phones, portable computers, and plasma displays.

ALOX™ substrate technology is a unique multilayer substrate technology developed for microelectronics packaging applications. The process is simple and low cost, and contains a low number of process steps. The ALOX™ substrate technology serves as a wide technology platform, and can be implemented in various electronics packaging applications such as for RF, SiP, 3-D memory stacks, MEMS and high power modules and components. ALOX™ technology is described in U.S. Pat. No. 5,661,341 “Method of Manufacturing a Composite Structure for Use in Electronic Devices and Structure, Manufactured by Said Method”; U.S. Pat. No. 6,448,510 “Substrate for Electronic Packaging, Pin Jig Fixture”; U.S. Pat. No. 6,670,704 “Device for Electronic Packaging, Pin Jig Fixture”; International Patent Publication No. WO 00/31797, International Patent Publication No. WO 04/049424, and U.S. Patent Application Pub No. 2007/0080360 “Microelectronic Interconnect Substrate and Packaging Techniques”, all of which are incorporated herein by reference in their entirety.

A starting material in an ALOX™ process is a conductive aluminum sheet. A first step in the process is masking the top and bottom of the sheet using conventional lithography techniques (for example, photoresist). Via structures, comprising solid aluminum, are formed using anodization of the sheet through the whole thickness of the sheet. The exposed areas are converted into aluminum oxide which is ceramic in nature and a highly insulating dielectric material. The protected unexposed areas remain as aluminum elements and form the connecting vias.

In its simplest form, an ALOX™ interconnect substrate is formed by electrochemical anodic oxidation of selected portions of an initially conductive valve metal (for example, aluminum) substrate resulting in areas (regions) of conductive (starting) material which are geometrically defined and isolated from one another by areas (regions) of anodized (non-conductive, such as aluminum oxide, or alumina) isolation structures. “Vertical” isolation structures extend into the substrate, including completely through the substrate. “Horizontal” isolation structures extend laterally across the substrate, generally just within a surface thereof Anodizing from one or both sides of the substrate can be performed to arrive at complex interconnect structures.

In a more complex form (such as disclosed in U.S. Pat. No. 6,670,704), a multilayer low cost ceramic board is formed using this process. A complete “three metal layer” core contains an internal aluminum layer, top and bottom patterned copper layers with through vias and blind vias incorporated in the structure.

### GLOSSARY

Unless otherwise noted, or as may be evident from the context of their usage, any terms, abbreviations, acronyms or scientific symbols and notations used herein are to be given their ordinary meaning in the technical discipline to which the disclosure most nearly pertains. The following terms, abbreviations and acronyms may be used throughout the descriptions presented herein and should generally be given the following meaning unless contradicted or elaborated upon by other descriptions set forth herein. Some of the terms set forth below may be registered trademarks (®).
anodization, one-sided An anodization process applied to a surface on one side of a metal sheet (or substrate). An example of such a process may include the use of ALOX™ substrate technology.
anodization, two-sided An anodization process applied to a surface on both sides of a metal sheet (or substrate). An example of such a process may include the use of ALOX™ substrate technology.
ALOX™ A substrate technology (proprietary to Micro Components Ltd. of Ramat-Gabriel, Israel) wherein the substrate is metal based, made of a combination of aluminum metal and aluminum oxide based dielectric material forming a multi layer interconnect substrate, typically in a BGA format.
Aluminum Aluminium, or aluminum (Symbol Al).
Aluminium oxide An amphoteric oxide of aluminium (for example, having the chemical formula Al₂O₃), also commonly referred to as alumina.
array A set of elements (usually referring to leads or balls in the context of semiconductor assembly) arranged in rows and columns.
assembly The process of putting a semiconductor device or integrated circuit in a package of one form or another; it usually consists of a series of packaging steps that include: die preparation, die attach, wire bonding, encapsulation or sealing, deflash, lead trimming/forming, and lead finish.
ball bond A bond that looks like a ball (generally spherical).
ball grid array (BGA) A surface-mount package that utilizes an array of metal spheres or balls as the means of providing external electrical interconnection, as opposed to the pin-grid array (PGA) which uses an array of leads for that purpose.
CBGA Short for ‘Ceramic Ball Grid Array’.
chip A portion of a semiconductor wafer, typically containing an entire circuit which has not yet been packaged
chip-scale package (CSP) Any package whose dimensions do not exceed the die's dimensions by 20%.
die 1. A single chip from a wafer; 2. A small block of semiconductor material containing device circuitry.
die attach The assembly process step wherein the die is mounted on the support structure of the package, for example, the leadframe, die pad, cavity, or substrate.
die Used synonymously with “chip”. Plural, “dies” or “dice”.
heat sink Devices used to absorb or transfer (conduct) heat away from heat sensitive devices or electronic components.
IC or ICC Short for Integrated Circuit, or Integrated Circuit Chip.
Interconnect Substrate As used herein, an interconnect substrate is a typically flat substrate used to connect electronic components with one another and having patterns of conductive traces in at least one layer for effecting routing of signals (and power) from one electronic component to another, or to the outside world. Typically, an interconnect substrate has many metallization layers with the conductive traces, and vias connect selected traces from one layer to selected traces of another layer.
interposer An intermediate layer or structure that provides electrical connection between the die and the package.
leadframe A metal frame used as skeleton support to provide electrical connections to a chip in many package types.
Light Emitting Diode (LED) A junction diode which give off light (and also generates some heat) when energized.
mask Broadly speaking, a mask is any material forming a pattern for a subsequent process to selectively affect/alter certain areas of a semiconductor substrate, and not others. Photoresist is a commonly-used masking material which is applied to the substrate, then washed off (stripped) after the desired process is completed.
MCM Short for multi-chip module. In accordance with a basic definition and classification, given in “Thin film multichip modules” by George Messner, Iwona Turlik, John W. Balde and Philip E. Garrou, edited by the International Society for Hybrid Microelectronics, 1992, the multichip module is a device, which provides the interconnections for several chips that are subsequently protected by a coating or an enclosure. In accordance with different approaches and fabrication techniques, the MCMs known today can be divided into 3 main groups:
MCM-C Short for ‘Multi-Chip Module-Ceramic’. MCM-Cs are multichip modules which use sinterable metals to form the conductive patterns of signal and power layers, which are applied onto a substrate made of ceramic or glass-ceramic material.
MCM-L Short for ‘Multi-Chip Module-Laminate’. MCM-Ls are multichip modules which use laminate structures and employ printed circuit technologies to form a pattern of signal and power layers, which are applied onto layers made of organic insulating material.
MCM-D Short for ‘Multi-Chip Module-Dense’. MCM-Ds are multichip modules on which layers of metal and insulator are usually formed by the deposition of thin film onto a rigid support structure usually made of silicon, ceramic, or metal.
MEMS Short for Micro Electro Mechanical Systems. MEMS micromachined in silicon, typically integrated with electronic microcircuits, generally fall into two categories of micro sensors and micro actuators; depending on application operation based on electrostriction, or electromagnetic, thermo elastic, piezoelectric, or piezoresistive effect.
microelectronics The branch of electronics that deals with miniature (often microscopic) electronic components.
molding The assembly process step wherein the devices are encapsulated in plastic; also referred to as ‘encapsulation’.
package A container, case, or enclosure for protecting a (typically solid-state) electronic device from the environment and providing connections for integrating a packaged device with other electronic components.
photoresist (resist) Photoresist (PR) is a photo-sensitive material used in photolithography to transfer a pattern from a mask onto a wafer. Typically, a liquid deposited on the surface of the wafer as a thin film then solidified by low temperature anneal. Exposure to light (irradiation) changes the properties of the photoresist, specifically its solubility. “Negative” resist is initially soluble, but becomes insoluble after irradiation. “Positive” resist is initially insoluble, but becomes soluble after irradiation. Photoresist is often used as an etch mask. In the context of the present disclosure, photoresist may be used as an oxidation mask.
PWB Short for printed wiring board. Also referred to as printed circuit board (PCB).
RF Short for ‘Radio Frequency’. RF refers to that portion of the electromagnetic spectrum in which electromagnetic waves can be generated by alternating current fed to an antenna.
semiconductors 1. Any of various solid crystalline substances, such as germanium or silicon, having electrical conductivity greater than insulators but less than good conductors, and used especially as a base material for computer chips and other electronic devices. 2. An integrated circuit or other electronic component containing a semiconductor as a base material.
SIP Short for ‘System-in-a-Package’—a package that contains several chips and components that comprise a completely functional stand-alone electronic system (also acronym for ‘Single-in-Line Package’—a through-hole package whose leads are aligned in just a single row, but that definition is not used in the description herein).
SMD Short for ‘Surface-Mount Device’.
SMT Short for ‘Surface-Mount Technology’.
substrate 1. The base material of the support structure of an IC; 2. The surface where the die or other components are mounted in electronic packaging; 3. The semiconductor block upon which the integrated circuit is built.
surface-mount A phrase used to denote that a package is mounted directly on the top surface of the board, as opposed to ‘through-hole’, which refers to a package whose leads need to go through holes in the board in order to get them soldered on the other side of the board.
valve metal A metal, such as aluminum, which is normally electrically conductive, but which can be converted such as by oxidation to both a non-conductor (insulator) and chemical resistance material. Valve metals include aluminum (Al, including Al 5052, Al 5083, Al 5086, Al 1100, Al 1145, and the like), titanium, tantalum, also niobium, europium.
via A metallized or plated-through hole, in an insulating layer, for example, a substrate, chip or a printed circuit board which forms a conduction path itself and is not designed to have a wire or lead inserted therethrough. Vias can be either straight through (from front to back surface of the substrate) or “blind”. A blind via is a via that extends from one surface of a substrate to within the substrate, but not through the substrate.
wire bond Attachment of a tiny wire, as by thermo compression bonding and/or ultrasound, to a bonding pad on a semiconductor chip substrate bond finger.
wirebonding An assembly process or step that connects wires between the die and the bonding sites of the package (for example, the lead fingers of the leadframe or the bonding posts of the package).

### SUMMARY

An aspect of some embodiments of the invention relates to providing a method for deep anodization of at least a portion of a thick substrate comprising a thick valve metal base (minimum thickness 200 μm), wherein the anodization reaches a depth of at least 200 μm into the base from a surface of the base exposed to an anodization process. By using the disclosed method, for example, anodization may be used for via forming in a thick substrate of thickness at least 0.4 mm. Via forming in a thick substrate provides for substantially high breakdown voltage, and for high power dissipation in micromechanical, optical, thermal applications For convenience hereinafter, the method may be referred to as ‘deep anodization’. A method for deep anodization is described in Provisional Patent Application No. 60/924656 filed 24 May 2007, which is incorporated herein by reference in its entirety.

According to an aspect of some embodiments of the invention, the method comprises, prior to anodization, partially reducing a thickness of one or more portions of the base which are to undergo deep anodization. For convenience hereinafter, “partially reducing the thickness of a portion” may be used interchangeably with “thickness reduction”. Thickness reduction may include forming indentations such as, for example, recesses, openings (for example, blind holes), cavities, grooves, etchings, or any combination thereof, on the surface of the base comprising the portion. In an embodiment of the invention, the method comprises one-sided deep porous anodization and includes thickness reduction and anodization from one side of the base. Optionally, the method comprises two-sided deep porous anodization and includes thickness reduction and anodization from two sides of the base. Thickness reduction may be performed by using methods known in the art, such as, for example, chemical or electrochemical or dry etching through an opening in a mask; jet spraying of an etchant; or through mechanical means such as milling, stamping, electro erosion, ultrasound cutting, laser cutting, or any combination thereof

In some embodiments of the invention, deep anodization may be used to create vertical isolated structures in a thick ALOX™ substrate. The thick ALOX™ substrate may then be adapted for packaging high power electronics, such as, for example, high power LEDs, high power RF, and/or other types of high power modules.

There is provided, in accordance with an embodiment of the invention, a method of anodizing comprising anodizing at least a portion of a valve metal base to a depth of at least 200 μm. The method further comprises creating, prior to anodization, an indentation on at least a portion of at least one surface of the base. Optionally, the anodization is performed on at least a portion of the indentation.

In some embodiments of the invention, the method comprises creating the indentation on at least a portion of two surfaces of the base. Optionally, the anodization is performed on at least a portion of the indentation.

In some embodiments of the invention, the indentation comprises a blind hole. Optionally, the indentation comprises a groove. Optionally, the indentation comprises a recess. Additionally or alternatively, the indentation comprises a cavity. Optionally, the indentation comprises a channel. Optionally, the indentation comprises an etching.

In some embodiments of the invention, the base comprises aluminum. Optionally, anodizing comprises growing aluminum oxide (alox). Optionally, the method further comprises overlapping the alox grown from at least two indentations on at least a portion of at least one surface of the base. Additionally or alternatively, the method further comprises overlapping the alox grown from at least two indentations on at least a portion of two surfaces of the base.

In some embodiments of the invention, the base is a part of an ALOX™ substrate. Optionally, the method further comprises creating an essentially vertical isolating structure in the substrate.

There is provided, in accordance with an embodiment of the invention, a substrate comprising a valve metal base comprising at least a portion anodized to a depth of minimum 200 μm. Optionally, the valve metal base comprises aluminum. Optionally, the anodized portion comprises alox.

In some embodiments of the invention, the substrate further comprises an ALOX™ substrate. Optionally, the substrate comprises an essentially vertical isolating structure formed by anodization. Optionally, the substrate further comprises an aluminum via having a minimum thickness of 200 μm.

There is provided, in accordance with an embodiment of the invention, a substrate comprising a valve metal base comprising at least a portion anodized to a depth of minimum 200 μm wherein the portion was produced by creating, prior to anodization, an indentation on at least a portion of at least one surface of the base. The substrate further comprises an indentation on at least a portion of two surfaces of the base. Optionally, at least a portion of the indentation is anodized. Optionally, the indentation comprises a blind hole. Optionally, the indentation comprises a groove. Optionally, the indentation comprises a recess. Additionally or alternatively, the indentation comprises a cavity. Optionally, the indentation comprises a channel. Optionally, the indentation comprises an etching. Optionally, the base comprises aluminum. Optionally, anodizing comprises growing aluminum oxide (alox). Additionally or alternatively, the alox grown is from at least two indentations on at least a portion of at least one surface of the base overlap. Optionally, the alox is grown from at least two indentations on at least a portion of two surfaces of the base. Optionally, the base is a part of an ALOXTM substrate.

There is provided, in accordance with an embodiment of the invention, an interconnect substrate comprising a valve metal base comprising at least a portion anodized to a depth of minimum 200 μm, wherein the portion was produced by creating, prior to anodization, an indentation on at least a portion of at least one surface of the base.

There is provided, in accordance with an embodiment of the invention, an electronic device comprising a substrate comprising a valve metal base, the valve metal base comprising at least a portion anodized to a depth of minimum 200 μm, wherein the portion was produced by creating, prior to anodization, an indentation on at least a portion of at least one surface of the base.

There is provided, in accordance with an embodiment of the invention, an electronic device comprising an interconnect substrate comprising a valve metal base, the valve metal base comprising at least a portion anodized to a depth of minimum 200 μm wherein the portion was produced by creating, prior to anodization, an indentation on at least a portion of at least one surface of the base.

### BRIEF DESCRIPTION OF FIGURES

Examples illustrative of embodiments of the invention are described below with reference to figures attached hereto. In the figures, identical structures, elements or parts that appear in more than one figure are generally labeled with a same numeral in all the figures in which they appear. Dimensions of components and features shown in the figures are generally chosen for convenience and clarity of presentation and are not necessarily shown to scale. The figures are listed below.

FIG. 1 A schematically illustrates an isometric view of an exemplary substrate in an implementation of the method, prior to anodization and comprising indentations for thickness reduction, in accordance with an embodiment of the invention;

FIG. 1B schematically illustrates a cross-sectional view A-A of the substrate shown in FIG. 1A, in accordance with an embodiment of the invention;

FIG. 1C schematically illustrates a cross-sectional view B-B of the substrate shown in FIG. 1A, in accordance with an embodiment of the invention;

FIG. 2A schematically illustrates an isometric view of the substrate shown in FIG. 1A following anodization, in accordance with an embodiment of the invention;

FIG. 2B schematically illustrates a cross-sectional view A-A of the substrate shown in FIG. 2A, in accordance with an embodiment of the invention;

FIG. 2C schematically illustrates a cross-sectional view B-B of the substrate shown in FIG. 2A, in accordance with an embodiment of the invention;

FIG. 2D schematically illustrates an isometric view of an exemplary substrate in an implementation of the method, following anodization, in accordance with an embodiment of the invention;

FIG. 2E schematically illustrates a cross-sectional view C-C of the substrate shown in FIG. 2D, in accordance with an embodiment of the invention;

FIG. 2F schematically illustrates a cross-sectional view D-D of the substrate shown in FIG. 2D, in accordance with an embodiment of the invention;

FIGS. 3A-3E schematically illustrate several non-limiting, exemplary plan views of a alox configurations on a portion of a surface of a substrate following implementation of the method, marked A-H, in accordance with some embodiments of the invention;

FIGS. 4A-4E and 4A′-4E′ schematically illustrate several non-limiting, exemplary cross-sectional views of alox configurations on a portion of a substrate prior to anodization; and the same cross-sectional views of the portion following anodization, respectively, in accordance with some embodiments of the invention;

FIG. 5 schematically illustrates an exemplary thick ALOX™ substrate following deep anodization and comprising vertical isolated structures, in accordance with some embodiments of the invention; and

FIG. 6 illustrates a flow diagram of an exemplary method of performing deep anodization, in accordance with an embodiment of the invention.

### DETAILED DESCRIPTION

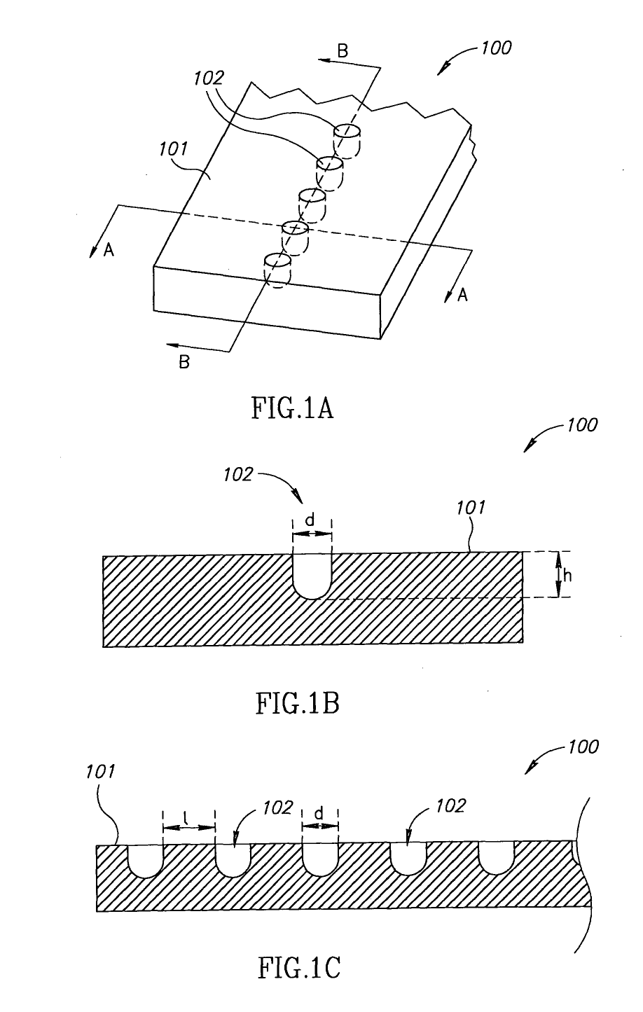

Reference is made to FIG. 1A, which schematically illustrates a partial isometric view of an exemplary substrate 100 in an implementation of the method, prior to anodization, and comprising indentations, such as for example, blind holes 102, for thickness reduction in a valve metal base 101; to FIG. 1B which schematically illustrates a cross-sectional view A-A of substrate 100; and to FIG. 1C which schematically illustrates a cross-sectional view B-B of substrate 100, all in accordance with an embodiment of the invention. Base 101 may be fabricated from valve metals, such as, for example, aluminum.

In accordance with an embodiment of the invention, blind holes 102 are created on a portion of a surface on one side of base 101 as a step of a one-sided deep anodization process. Holes 102 are of diameter d and depth h, and are spaced a distance l from one another, the dimensions d, h, and/or l selected so as to satisfy a predetermined criteria for area and depth to be anodized in base 101. In selecting d, h, and l, consideration is given to a type of anodization process used and a growth amount of aluminum oxide (alox) into metal and out of metal. For example, when using a porous anodization process, such as, for example, that used to create an ALOX™ substrate, alox growth into aluminum may be approximately 70%, while out of the aluminum, growth may be approximately 30%. Optionally, holes 102 may include shapes other than circular, for example, elliptical, triangular, rectangular, or any other polygonal shape, or any combination thereof. Additionally or alternatively, holes 102 may be connected to one another to form grooves, channels, and the like. Holes 102 may be created by methods known in the art, such as, for example, chemical or electrochemical or dry etching through an opening in mask; jet spraying of an etchant; or through mechanical means such as milling, stamping, electro erosion, ultrasound cutting, laser cutting, or any combination thereof.

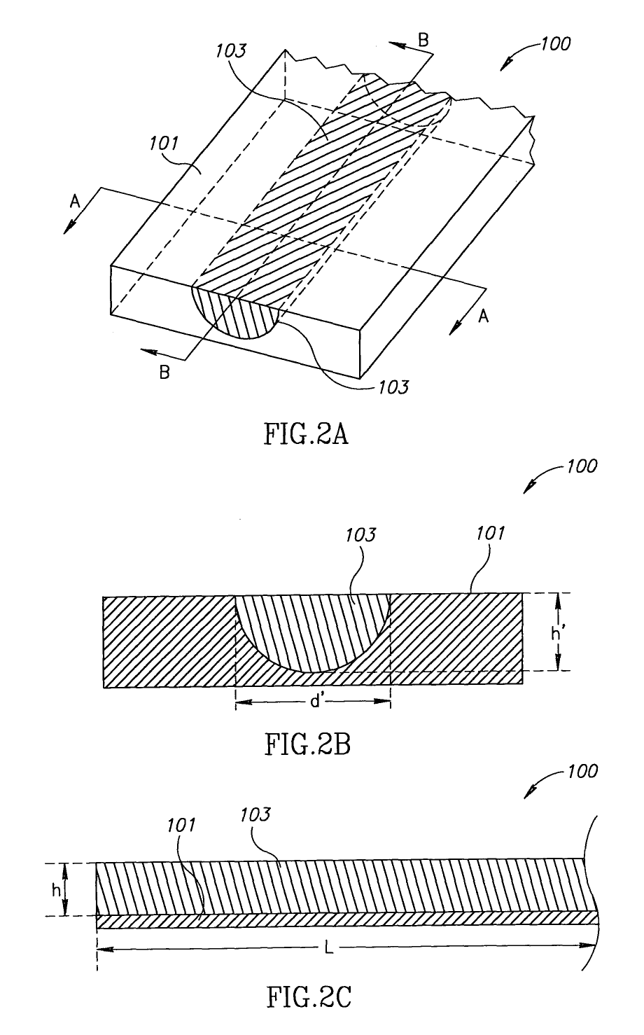

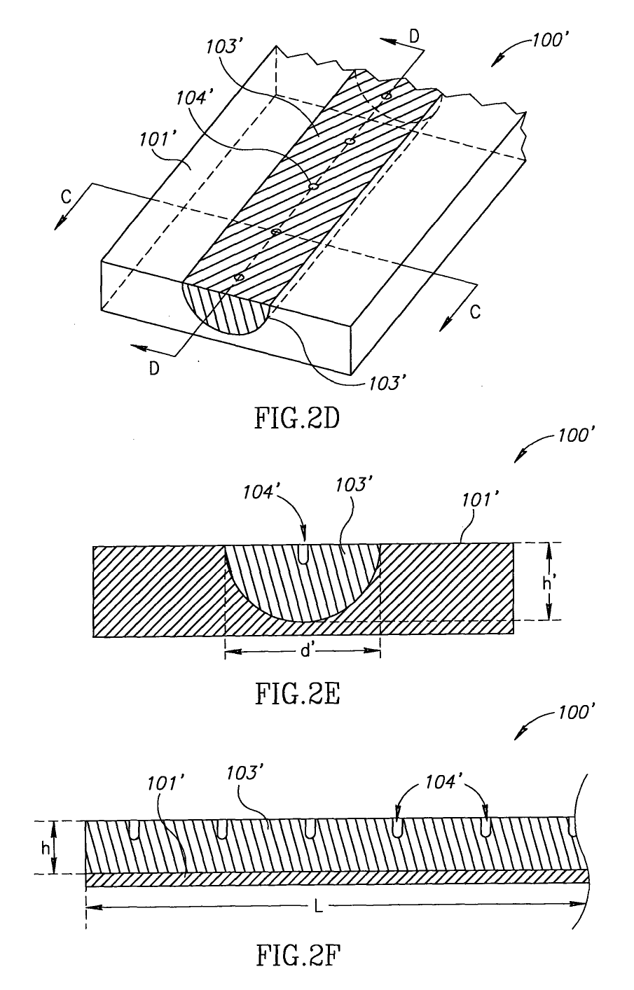

Reference is made to FIG. 2A, which schematically illustrates a partial isometric view of exemplary substrate 100 shown in FIG. 1A following one-sided deep anodization; to FIG. 2B which schematically illustrates a cross-sectional view A-A of substrate 100 shown in FIG. 2A; and to FIG. 2C which schematically illustrates a cross-sectional view B-B of substrate 100 shown in FIG. 2A, all in accordance with an embodiment of the invention.

In accordance with an embodiment of the invention, dimensions d, h, and l are selected so that a growth of alox 103 into base 101, through each hole 102, substantially reaches a predetermined depth h′ exceeding 204m, and overlaps with that of the adjacent hole a distance l away. Furthermore, dimension h in hole 102 may be selected such that growth of alox 103 inside the hole substantially fills the hole to a height substantially in the same plane as the side of base 101 in which the hole was created. For example, in the creation of a thick ALOX™ substrate (alox growth into aluminum is approximately 70%, while out of the aluminum, growth is approximately 30%), selecting the depth of a hole to be approximately 30% of the total thickness of the alox will result in a substantially completely filled hole during the porous anodization process, a top of the hole essentially lying in a same plane as a side of a base in which the hole was created. The result is the creation of a strip of alox 103 which extends a depth h′ into base 101, and covers an approximate area on a portion of base 101 of width d′ and length L. Each blind hole 102 is fully filled.

In another embodiment of the invention, dimension h in hole 102 may be selected such that the hole is not completely filled. Reference is made to FIG. 2D which schematically illustrates a partial isometric view of an exemplary substrate 100′ following one-sided deep anodization; to FIG. 2E which schematically illustrates a cross-sectional view C-C of substrate 100′ shown in FIG. 2D; and to FIG. 2F which schematically illustrates a cross-sectional view D-D of substrate 100′ shown in FIG. 2D, all in accordance with another embodiment of the invention. Reference is also made to FIG. 1. Exemplary substrate 100′, prior to anodization, may be the same or substantially similar to that shown in FIG. 1 at 100.

In accordance with another embodiment of the invention, dimensions d, h, and l in base 101 are selected so that a growth of alox 103′ into base 101′ substantially reaches a predetermined depth h′ exceeding 200 μm and overlaps with alox 103′ growth from an adjacent hole 102 a distance l away (holes 102 are shown in FIG. 1). This results in the creation of a strip of alox 103′ which extends a depth h′ into base 101′, and covers an approximate area on a portion of base 101′ of width d′ and length L. Each blind hole 102 in base 101 has been reduced to a small hole 104′ in base 101′ during the anodization process due to the growth of alox 103′ outwards from the metal.

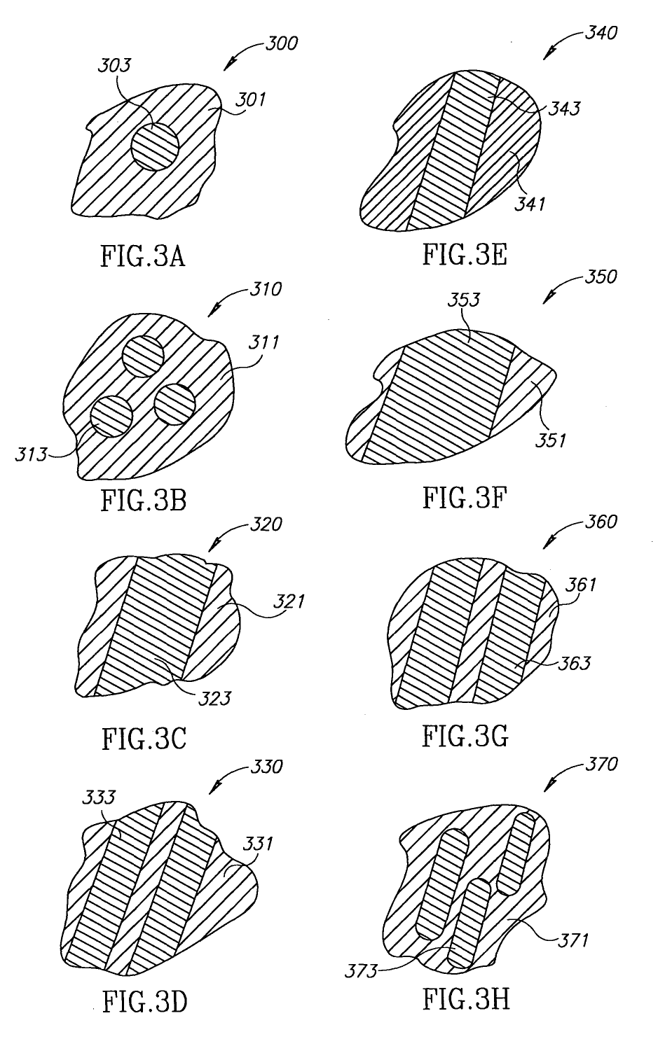

Reference is made to FIGS. 3A-3H which schematically illustrate several non-limiting, exemplary plan views of alox configurations on a portion of a surface of a substrate following implementation of the method, in accordance with some embodiments of the disclosure. The method may comprise one-sided deep anodization, or optionally, two-sided deep anodization. Thickness reduction by creating indentations may be performed by using methods known in the art, such as, for example, chemical or electrochemical or dry etching through an opening in a mask; jet spraying of an etchant; or through mechanical means such as milling, stamping, electro erosion, ultrasound cutting, laser cutting, or any combination thereof. Anodization may be performed using methods known in the art, for example, porous anodization.

FIG. 3A shows a substrate 300 including a section of an aluminum base 301 with one, essentially circular area of alox 303, following a deep anodization process using a blind hole for thickness reduction. The blind hole may be the same or substantially similar to that shown in FIG. 1 at 102, and has been filled during the anodization process due to the growth of alox 303 outwards from the metal. Substrate 300, including aluminum base 301 and alox 303, may be the same or substantially similar to that shown in FIGS. 2A-2C at 100, 101, and 103.

FIG. 3B shows a substrate 310 including a section of an aluminum base 311 with three, essentially circular areas of grown alox 313, following a deep anodization process using blind holes for thickness reduction. The blind hole may be the same or substantially similar to that shown in FIG. 1 at 102. Each circular area of alox 313 was created from a blind hole, the distance between the holes selected such that the grown circular areas are physically separated from one another by portions of aluminum base 311. Each blind hole has been filled during the anodization process due to the growth of alox 313 outwards from the metal. Substrate 310, including aluminum base 311 and alox 313, may be the same or substantially similar to that shown in FIGS. 2A-2C at 100, 101, 102 and 103.

FIG. 3C shows a substrate 320 including a section of an aluminum base 321 with a relatively large area of grown alox 323, following a deep anodization process using blind holes for thickness reduction. The blind holes may be the same or substantially similar to that shown in FIG. 1 at 102. The area of grown alox 323 was created from two rows of blind holes, the distance between the holes selected such that the alox grown from each hole overlaps with the alox grown in an adjacent blind hole in the same row, and with an adjacent blind hole in the adjacent row. Each blind hole has been filled during the anodization process due to the growth of alox 323 outwards from the metal. Substrate 320, including aluminum base 321 and alox 323, may be the same or substantially similar to that shown in FIGS. 2A-2C at 100, 101, 102 and 103.

FIG. 3D shows a substrate 330 including a section of an aluminum base 331 with two strips of grown alox 333, following a deep anodization process using blind holes for thickness reduction. The blind holes may be the same or substantially similar to that shown in FIG. 1 at 102. Each strip of grown alox 333 was created from a row of blind holes, the distance between the holes selected such that the alox grown from each hole overlaps with the grown alox of an adjacent blind hole in the same row. The two rows of blind holes were separated by a distance such that two strips of grown alox 333 are separated by a portion of aluminum base 331. Each blind hole has been filled during the anodization process due to the growth of alox 333 outwards from the metal. Substrate 330, including aluminum base 331 and alox 333, may be the same or substantially similar to that shown in FIGS. 2A-2C at 100, 101, 102, and 103.

FIG. 3E shows a substrate 340 including a section of an aluminum base 341 with a relatively large strip of grown alox 343, following a deep anodization process using a groove for thickness reduction. Optionally, the groove may be a channel, a recess, or the like. The groove has been filled during the anodization process due to the growth of alox 343 outwards from the metal. Substrate 340, including aluminum base 341 and alox 343 may be the same or substantially similar to that shown in FIGS. 2A-2C at 200, 201, and 203.

FIG. 3F shows a substrate 350 including a section of an aluminum base 351 with a relatively large area of grown alox 353, following a deep anodization process using three grooves for thickness reduction. Optionally, the grooves may be a channel, a recess, or the like, or any combination thereof. The distance between the grooves was selected such that alox 353 grown from each groove overlaps with the alox grown area from a groove in the adjacent row. Each groove has been filled during the anodization process due to the growth of alox 353 outwards from the metal. Substrate 350, including aluminum base 351 and alox 353 may be the same or substantially similar to that shown in FIGS. 2A-2C at 200, 201, and 203.

FIG. 3G shows a substrate 360 including a section of an aluminum base 361 with two strips of grown alox 363, following a deep anodization process using grooves for thickness reduction. Optionally, the grooves may be a channel, a recess, or the like, or any combination thereof. Each strip of grown alox 363 was created from a groove, the distance between the grooves selected such that two strips of grown alox are separated by a portion of aluminum base 361. Each groove has been filled during the anodization process due to the growth of alox 363 outwards from the metal. Substrate 360, including aluminum base 361 and alox 363, may be the same or substantially similar to that shown in FIGS. 2A-2C at 200, 201 and 203.

FIG. 3H shows a substrate 370 including a section of an aluminum base 371 with three strips of grown alox 373, following a deep anodization process using grooves for thickness reduction. Optionally, the grooves may be a channel, a recess, or the like, or any combination thereof Each strip of grown alox 373 was created from a groove, the distance between the grooves selected such that three strips of grown alox are separated from one another by a portion of aluminum base 371. Each groove has been filled during the anodization process due to the growth of alox 373 outwards from the metal. Substrate 370, including aluminum base 371 and alox 373, may be the same or substantially similar to that shown in FIGS. 2A-2C at 200, 201 and 203.

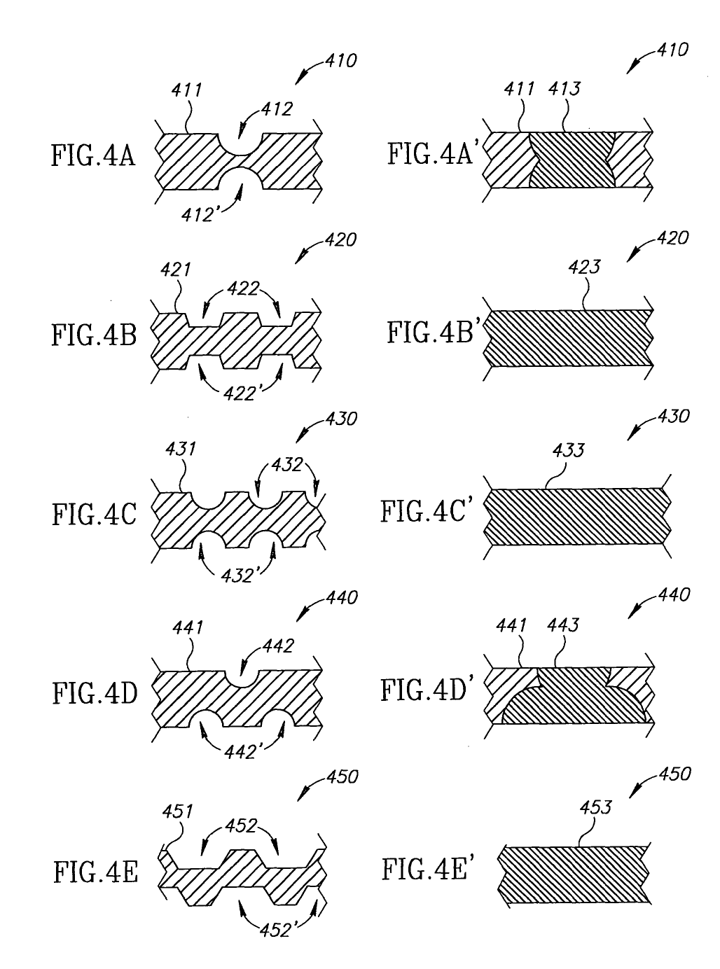

Reference is made to FIGS. 4A-4E which schematically illustrate several non-limiting, exemplary cross-sectional views of thickness reduction configurations on a portion of a substrate, prior to anodization; and to FIGS. 4A′-4E′ which schematically illustrate the same cross-sectional views of the portion following deep anodization, in accordance with some embodiments of the disclosure. The method illustrated comprises two-sided deep anodization, and may optionally include one-sided deep anodization. Thickness reduction by creating indentions may be performed by using methods known in the art, such as, for example, chemical or electrochemical or dry etching through an opening in a mask; jet spraying of an etchant; or through mechanical means such as milling, stamping, electro erosion, ultrasound cutting, laser cutting, or any combination thereof. Anodization may be performed using methods known in the art, for example, porous anodization.

FIG. 4A shows a substrate 410, including a section of an aluminum base 411 comprising a blind hole 412 created on one side of the base, and a second blind hole 412′ created on an opposite side of the base, the holes substantially aligned such that one is on top of the other. Following two-sided deep anodization, cross-sectional view FIG. 4A′ shows growth of alox 413 from blind holes 412 and 412′ into and out of base 411 in the areas of the holes. Alox 413 overlaps to form an anodized section covering a thickness of the base, over a portion of the section. Blind holes 412 and 412′ have been filled during the anodization process due to the growth of alox 413 outwards from the metal. Substrate 410, including aluminum base 411, holes 412 and 412′, and alox 413, may be the same or substantially similar to that shown in FIGS. 1A-1C and/or 2A-2C at 100, 101, 102, and 103, respectively.

FIG. 4B shows a substrate 420, including a section of an aluminum base 421 comprising a series of blind holes 422 created on one side of the base, and a second series of blind hole 422′ created on an opposite side of the base, the holes substantially aligned such that one is on top of the other. Following two-sided deep anodization, cross-sectional view FIG. 4B′ shows growth of alox 423 from blind holes 422 and 422′ into and out of base 421 in the areas of the holes. Alox 423 overlaps to form an anodized section covering a thickness of the base over the whole section. Blind holes 422 and 422′ have been filled during the anodization process due to the growth of alox 423 outwards from the metal. Substrate 420, including aluminum base 421, hole 422 and 422′, and alox 423, may be the same or substantially similar to that shown in FIGS. 1A-1C and/or 2A-2C at 100, 101, 102, and 103, respectively, with the exception that blind holes 422 and 422′ are rectangular shaped.

FIG. 4C shows a substrate 430, including a section of an aluminum base 431, comprising a series of blind holes 432 created on one side of the base, and a second series of blind holes 432′ created on an opposite side of the base, the holes substantially aligned such that one hole on one side is on top of a hole on the other side. Following two-sided deep anodization, cross-sectional view FIG. 4C′ shows growth of alox 433 from blind holes 432 and 432′ into and out of base 431 in the areas of the holes. Alox 433 overlaps to form an anodized section covering a thickness of the base over the whole section. Blind holes 432 and 432′ have been filled during the anodization process due to the growth of alox 433 outwards from the metal. Substrate 430, including aluminum base 431, holes 432 and 432′, and alox 433, may be the same or substantially similar to that shown in FIGS. 1A-1C and/or 2A-2C at 100, 101, 102, and 103, respectively.

FIG. 4D shows a substrate 440, including a section of an aluminum base 441, comprising a blind hole 442 created on one side of the base, and two blind holes 442′ created on an opposite side of the base, the holes on one side non-aligned with respect to the holes on the other side. Following two-sided deep anodization, cross-sectional view FIG. 4D′ shows growth of alox 443 from blind holes 442 and 442′ into and out of base 441 in the areas of the holes. Alox 443 overlaps to form an anodized section covering a thickness of the base, over a portion of the section comprised by three blind holes 442 and 442′. Blind holes 442 and 442′ have been filled during the anodization process due to the growth of alox 443 outwards from the metal. Substrate 440, including aluminum base 441, holes 442 and 442′, and alox 443, may be the same or substantially similar to that shown in FIGS. 1A-1C and/or 2A-2C at 100, 101, 102, and 103, respectively.

FIG. 4E shows a substrate 450, including a section of an aluminum base 451, comprising a series of blind holes 452 created on one side of the base, and a second series of blind holes 452′ created on an opposite side of the base, the holes on one side non-aligned with respect to the holes on the other side. Following two-sided deep anodization, cross-sectional view FIG. 4E′ shows growth of alox 453 from blind holes 452 and 452′ into and out of base 451 in the areas of the holes. Alox 453 overlaps to form an anodized section covering a thickness of the base over the whole section. Blind holes 452 and 452′ have been filled during the anodization process due to the growth of alox 453 outwards from the metal. Substrate 450, including aluminum base 451, holes 452 and 452′, and alox 453, may be the same or substantially similar to that shown in FIGS. 1A-1C and/or 2A-2C at 100, 101, 102, and 103, respectively, with the exception that blind holes 452 and 452′ are rectangular shaped.

It should be clear to a person skilled in the art that there are numerous alox configurations which may be created in substrates using the described method, and that those shown above in the plan views and/or cross-sectional views are not intended to be limiting in any form or manner. Furthermore, there are numerous types, quantities, and dimensions, of indentations which may be used, including combination of types, and those shown (blind holes and/or grooves) are not intended to be limiting in any way. Additionally, the substrate may comprise any valve metal, the use of the aluminum base (and alox) intended for exemplary purposes.

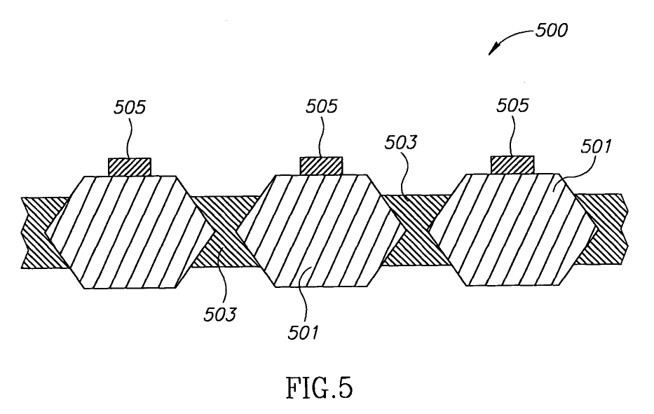

Reference is made to FIG. 5 which schematically illustrates an exemplary thick ALOX™ substrate 500 following deep anodization and comprising vertical isolated structures 503, in accordance with some embodiments of the invention. Thick ALOX™ substrate 500 is adapted to conduct heat from high power dissipating electronic component 505 through aluminum via 501 to a heat sink (not shown). In accordance with some embodiments of the invention, a thickness of aluminum via 501 is at least 200 μm. Substrate 500 comprises a plurality of aluminum vias 501, the aluminum sections electrically isolated from one another by vertical isolated structures 503 which extend from one side of the substrate to the other. In accordance with an embodiment of the invention, substrate 500 was formed by a two-sided deep anodization process comprising thickness reduction, vertical island structures 503 comprising alox grown according to the method disclosed herein.

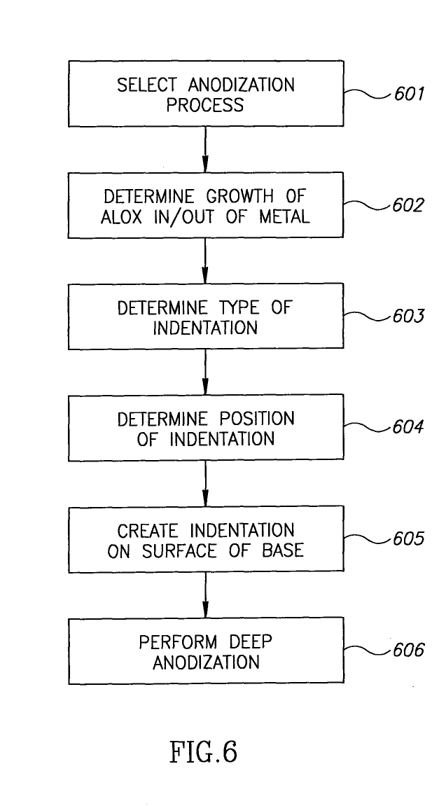

Reference is made to FIG. 6 which illustrates a flow diagram of an exemplary method of performing deep anodization, in accordance with an embodiment of the invention. For exemplary purposes, reference is made to FIGS. 1A-1C and FIGS. 2A-2C. It may be appreciated by a person skilled in the art that the method described herein may be applied in other sequences for the described embodiments, and may be applied in the same sequence described, or in other sequences, to other embodiments of the disclosure.

[STEP 601] Select an anodization process to be used in fabricating substrate 100.
[STEP 602] Determine the growth of alox 103 in and out of metal base 101. For example, when using an anodization process used to create an ALOX™ substrate, alox growth into aluminum is approximately 70% while, out of the aluminum, growth is approximately 30%.
[STEP 603] Determine the type of indentation to be created on the surface of the portion of base 101 to be anodized, for example, blind holes 102. The size and depth of the indentation is also determined. Optionally, the indentation may comprise channels, grooves, recesses, and the like, or any combination thereof.
[STEP 604] Determine the position of the indentation to be created on the surface of the portion of base 101 to be anodized. The position may be selected based on the decisions made in the prior steps, and is intended to allow overlapping of grown alox 103.
[STEP 605] Create the indentation on the surface of the portion of base 101 according to type and position.
[STEP 606] Perform deep anodization in indentations.

In the description and claims of embodiments of the present invention, each of the words, “comprise” “include” and “have”, and forms thereof, are not necessarily limited to members in a list with which the words may be associated.

The invention has been described using various detailed descriptions of embodiments thereof that are provided by way of example and are not intended to limit the scope of the invention. The described embodiments may comprise different features, not all of which are required in all embodiments of the invention. Some embodiments of the invention utilize only some of the features or possible combinations of the features. Variations of embodiments of the invention that are described and embodiments of the invention comprising different combinations of features noted in the described embodiments will occur to persons with skill in the art.

1.-42. (canceled)

43. A method of anodizing comprising:
anodizing at least a portion of a valve metal base to a depth of at least 200 μm.

44. The method of claim 43, further comprising creating, prior to anodization, an indentation on at least a portion of at least one surface of the base.

45. The method of claim 44, wherein the anodization is performed on at least a portion of the indentation.

46. The method of claim 44, comprising creating the indentation on at least a portion of two surfaces of the base.

47. The method of claim 46, wherein the anodization is performed on at least a portion of the indentation.

48. The method of claim 44, wherein the indentation comprises a blind hole.

49. The method of claim 44, wherein the indentation comprises a groove.

50. The method of claim 44, wherein the indentation comprises a recess.

51. The method of claim 44, wherein the indentation comprises a cavity.

52. The method of claim 44, wherein the indentation comprises a channel.

53. The method of claim 44, wherein the indentation comprises an etching.

54. The method of claim 43, wherein the base comprises aluminum.

55. The method of claim 43, wherein anodizing comprises growing aluminum oxide(ALOX).

56. The method of claim 55, further comprising overlapping the ALOX grown from at least two indentations on at least a portion of at least one surface of the base.

57. The method of claim 55, further comprising overlapping the ALOX grown from at least two indentations on at least a portion of two surfaces of the base.

58. The method of claim 43, wherein the base is a part of an ALOX substrate.

59. The method of claim 58, further comprising creating an essentially vertical isolating structure in the substrate.

60. A substrate comprising:
a valve metal base comprising at least a portion anodized to a depth of minimum 200 μm.

61. The substrate of claim 60, wherein the valve metal base comprises aluminum.

62. The substrate of claim 60, wherein the anodized portion comprises ALOX.

63. The substrate of claim 60, further comprising an essentially vertical isolating structures formed by anodization.
